(19) United States
(12) Patent Application Publication
(10) Pub. No.: US 2019/0322193 A1
(43) Pub. Date: Oct. 24, 2019

(54) BATTERY MODULE BALANCING SYSTEM OF A VEHICLE AND METHOD THEREOF

(71) Applicant: Wayne State University, Detroit, MI (US)

(72) Inventors: Chen Duan, Rochester, MI (US); Caisheng Wang, Troy, MI (US)

(21) Appl. No.: 16/389,134

(22) Filed: Apr. 19, 2019

Related U.S. Application Data
(60) Provisional application No. 62/659,755, filed on Apr. 19, 2018.

(51) Int. Cl. B60L 58/22; B60L 58/12; B60L 53/51; B60L 53/16

(52) U.S. Cl. CPC B60L 58/22; B60L 58/12; B60L 2210/10; B60L 53/16; B60L 53/51

(57) ABSTRACT

A battery module balancing system in a vehicle having a powertrain system includes a battery pack having at least one battery module, an electric generator for generating and providing a second voltage, a low voltage battery for storing or providing a first voltage and a controller being operable to balance a state-of-charge (SOC) in the battery module. The battery pack including the battery module has an energy for providing power to the powertrain system of the vehicle. In the battery balancing system, the controller determines to charge or discharge the battery module for balancing the SOC in each battery module based on each mode of the balancing system.

### CROSS-REFERENCE TO RELATED APPLICATION

This application claims priority to and the benefit of U.S. Provisional Patent Application No. 62/659,755, filed on Apr. 19, 2018, the entire contents of which are incorporated herein by reference.

### FIELD

The present disclosure relates to a control system and method for a vehicle having a battery balancing system.

### BACKGROUND

The statements in this section merely provide background information related to the present disclosure and may not constitute prior art.

Battery systems have been widely used in industry, transportation, energy storage applications for more than a century. Battery energy storage has been identified as an enabling technology for transportation electrification and smart grid applications, and battery systems further catalyze the synergy between electric vehicles (EVs) and the electric grid for delivering electricity.

In high power applications such as electric vehicles (EVs), hybrid electric vehicles (HEVs) and plug-in hybrid electric vehicles (PHEVs), the battery packs are usually formed by battery modules/cells connected in series to increase the voltage, and connected in parallel to increase the capacitance. However, due to manufacturing caused variations and varying operation conditions, the imbalances reduce the unusable energy. The imbalance of a battery pack could lead to negative outcomes such as early termination of charging and discharging process. Or, it can be even worse that the battery cells over-charged or over-discharged could be permanently damaged.

To deal with the imbalance issue of battery packs, various battery balancing systems have been developed. Passive balancing is one of the most widely used methods in battery management systems (BMS) because of the advantage of low cost. The operating principle of passive balancing is simple: When a single cell/module reaches the charge voltage limit, it will be discharged by a power resistor to allow other cells to be fully charged. However, passive balancing is only applied during the charge process instead of for both charge and discharge. In addition, the overall efficiency of the battery system with passive balancing is relatively low due to the balancing energy is dissipated as heat.

In contrast, active balancing circuits equalize the battery by transferring energy from cells with higher state-of-charge (SOC) to cells with lower SOC and can be operated during both charge and discharge processes. There are three types of state-of-the-art active balancing systems—Capacitive Balancing, Inductive Balancing and Mixed Active Balancing. However, each of the three active balancing systems has their own disadvantage. The main disadvantage of conventional active battery balancing system is the power loss during the balancing operation. The power loss wastes the useable energy of the whole battery pack. For example, in EVs, the result is the drop of the driving range of the vehicles.

The above information disclosed in this Background section is only for enhancement of understanding of the background of the present disclosure, and therefore it may contain information that does not form the prior art.

### SUMMARY

The present disclosure provides a battery module balancing system and method in a power assisted electric vehicle (EV), a hybrid electric vehicle (HEV) and a plug-in hybrid electric vehicle (PHEV).

According to an aspect of the present disclosure, the battery module balancing system includes a battery pack having at least one battery module, which has a state-of-charge (SOC), a low voltage battery for storing a first voltage and providing the first voltage to the battery pack, an electric generator for generating a second voltage to one of the battery pack and the low voltage battery, and a controller in communication with the at least one battery module, the electric generator, and the low voltage battery to provide the SOC of the at least one battery module. The battery pack has energy configured to provide power to a powertrain of the vehicle and the energy is defined by the SOC of the at least one battery module.

According to a further aspect of the present disclosure, the electric generator includes a solar power system. The solar power system generates the second voltage for balancing the SOC in the battery module by transmitting the second voltage to the battery module during discharging the energy from the battery pack.

According to a further aspect of the present disclosure, the battery module with a lowest voltage or SOC is charged by the second voltage for balancing the SOC in the battery module.

According to a further aspect of the present disclosure, the controller balances the SOC in the battery module by the second voltage generated from the solar power system when the vehicle is under driving and a solar power is available as a solar-balancing mode. The controller is further operable to charge the battery pack with the second voltage generated from the solar power system after the SOC in the battery module is balanced.

According to one aspect of the present disclosure, the controller balances the SOC in the battery module by the first voltage stored in the low voltage battery when the vehicle is under driving and a solar power is not available as a storage-balancing mode. The controller is further operable to stop transmitting the first voltage stored in the low voltage battery when the SOC in the battery module is balanced.

According to a further aspect of the present disclosure, the controller balances the SOC in the battery module by discharging a waste energy of the battery module with a highest voltage or SOC when the battery pack is charged by a plug-in charger. During charging the battery pack with the plug-in charger, the waste energy discharged from the battery module with the highest voltage or SOC is stored in the low voltage battery for preventing a loss of the waste energy, and the second voltage generated from the electric generator is stored in the low voltage battery when the electric generator is available.

According to a further aspect of the present disclosure, the battery module balancing system further includes a switch box, a DC/DC converter and a regulator for balancing the SOC in the battery module. A number of switch in the switch box is determined by doubling a number of the battery module in the battery pack.

According to a further aspect of further aspect of the present disclosure, the battery module balancing system further includes a plurality of dual-switches (DC) for selecting different operation modes by the controller.

According to an aspect of the present disclosure, a method for operating a battery module balancing system for balancing a state-of-charge (SOC) of at least one battery module in a battery pack includes steps of monitoring the SOC in the at least one battery module, determining a balancing operation mode based on external conditions of the vehicle, determining the battery module with a lowest SOC or the highest SOC and balancing the SOC in the battery module by charging or discharging the battery module.

According to a further aspect of the present disclosure, the controller determines a solar-balancing mode for charging the battery module with the lowest SOC by a second voltage generated from a solar power system when the vehicle is under driving and a solar power is available.

According to a further aspect of the present disclosure, the controller determines a storage-balancing mode for charging the battery module with the lowest SOC by a first voltage stored in a low voltage battery when the vehicle is under driving and a solar power is not available.

According to a further aspect of the present disclosure, the controller determines a charge-balancing mode for discharging a waste energy from the battery module with the highest SOC when the vehicle is parked and charged by a plug-in charger. During charging the battery pack with the plug-in charger, furthermore, the waste energy discharged from the battery module is stored in a low voltage battery for preventing a loss of the waste energy, and a second voltage generated from a solar power system is also stored in a low voltage battery when a solar power is available.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic view of a battery balancing module system in accordance with an exemplary form of the present disclosure;

FIG. 2 is a diagram illustrating a switch box circuit topology in accordance with the exemplary form of the present disclosure;

FIG. 3 is a schematic view of a solar balancing mode of the system in accordance with an exemplary form of the present disclosure;

FIG. 4 is a schematic view of a storage balancing mode of the system in accordance with an exemplary form of the present disclosure;

FIG. 5 is a schematic view of a charge balancing mode of the system in accordance with an exemplary form of the present disclosure; and

FIG. 6 is a flow chart illustrating an operation of a battery module balancing system in accordance with an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application or uses. It should be understood that throughout the drawings, corresponding reference numerals indicate like or corresponding parts and features.

Although an exemplary form is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present disclosure may be formed as non-transitory computer readable media on a computer readable medium containing executable program instruction executed by a processor, controller or the like. Examples of the computer readable mediums include, but are not limited to. ROM, RAM, compact disc (CD)-ROMs, magnetic tapes, floppy disks, flash drives, smart cards and optical data storage devices.

In electric vehicles (EVs), plug-in hybrid electric vehicles (PHEVs) and hybrid electric vehicles (HEVs), battery packs are usually formed by battery modules/cells connected in series to increase the voltage, and connected in parallel to increase the capacitance. For improving the energy loss and efficiency issues of conventional battery balancing system, the battery balancing system is configured to use the energy from an external source to charge the low state-of-charge (SOC) cell/modules. For example, the electric energy generated by an internal combustion engine or the solar energy from photovoltaic (PV) panels, can be used for this purpose. Due to the limited area availability for the PV installation, it is not feasible to use just solar energy to power the whole vehicle at the current stage. However, the solar energy can be used for battery balancing even if the solar power is limited.

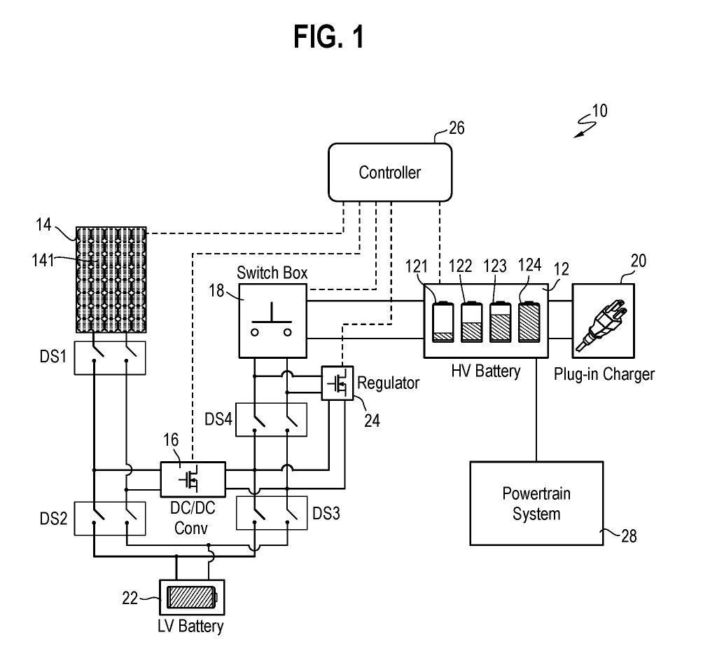

Referring to FIG. 1, a battery module balancing system 10 for a vehicle includes a battery pack 12, an electric generator 14, a DC/DC converter 16, a switch box 18, a plug-in charger 20, a low voltage battery 22 and a regulator 24. The battery module balancing system 10 further includes a controller 26 configured for controlling the balancing system 10 for the vehicle. The controller 26 is communicated with each of the battery pack 12, the electric generator 14, the DC/DC converter 16, the switch box 18, the plug-in charger 20, the low voltage battery 22 and the regulator 24, respectively.

As shown in FIG. 1, the battery pack 12 in the battery module balancing system 10 is connected with a powertrain system 28 including an electric motor (not shown) for providing power generated from the battery pack 12. As a high voltage battery in the balancing system 10, the battery pack 12 generally includes at least one battery module, which each has a state-of-charge (SOC) and is each connected each other for balancing in the system 10. In FIG. 1, for example, the battery pack 12 has four battery modules including a first, a second, a third and a fourth battery module 121, 122, 123 and 124. However, the number of the battery module in the battery pack 12 may be adjusted according to other form of the present disclosure.

In FIG. 1, for example, a solar power system 141 is used as the electric generator 14 in the battery module balancing system 10. However, other electric generators may be implemented according to other form of the present disclosure. The solar power system 141 in the battery module balancing system 10 is installed to the vehicle for absorbing sunlight during the day as a source of energy to generate electricity. Generally, the solar power system 141 includes a photovoltaic system that generates and supplies solar electricity in the balancing system 10 as shown in FIG. 1.

As shown in FIG. 1, the solar power system 141, DC/DC converter 16 and the high voltage battery pack 12 share a common DC bus for data communication in the system 10. The maximum output voltage of the DC/DC converter may be higher than the battery pack terminal voltage. It can also automatically recognize the input voltage and output terminal voltage, then charge each of the battery modules 121, 122, 123 and 124 connected to the output. The switch box 18 in the balancing system 10 is used to link the battery modules 121, 122, 123 and 124 with lowest/highest voltage or SOC that needs to be charged/discharged to the DC bus for keeping the balanced battery modules 121, 122, 123 and 124 in the battery pack 12.

In FIG. 1, the low voltage battery 22 is connected and communicated in the balancing system 10. The low voltage battery 22 is used for storing the energy generated from the electric generator 14. As shown in FIG. 1, for example, the low voltage battery 22 is used to store the solar energy generated from the solar power system 141 and actively discharge the energy for the main battery pack 12 during the time when the vehicle is parked for charging. Thus the battery modules 121, 122, 123 and 124 in the battery pack 12 can be balanced and fully charged even the solar power is unavailable during charging, for example, when the vehicle is parked indoor. In addition, when the vehicle is driving at night or under raining/cloudy weather without solar power available, the battery pack 12 can still be balancing by using energy from the low voltage battery 22 in the vehicle.

Generally, the low voltage battery 22 is charged by the high voltage battery in an EV and PHEV or by the internal combustion engine in a HEV constantly during driving. As shown in FIG. 1, during the parking and charging period, the battery pack 12 is charged by the conventional plug-in charger 20, and one of the battery modules 121, 122, 123 and 124 with the highest voltage or SOC is actively discharged by the regulator 24 to the low voltage battery 22 for balancing the battery modules in the system 10 so that the battery modules is effectively charged during its charging process. Thus the discharged energy is stored in the low voltage battery 22 so that the energy in the system 10 is not wasted for balancing the system 10.

If the rated voltage of the low voltage battery 22 is equal to or higher than the battery module voltage, the regulator 24 may be replaced by a Buck-Boost DC/DC converter to guarantee the energy can be transferred from one of the battery modules 121, 122, 123 and 124 to the low voltage battery 22. For example, when the solar power is low during rainy, cloudy time or at night, and the low voltage battery 22 acts as the balancing power source instead of the solar power. As shown in FIG. 1, accordingly, the different operation modes are selected by four dual-switches DS1, DS2, DS3 and DS4 on the DC bus.

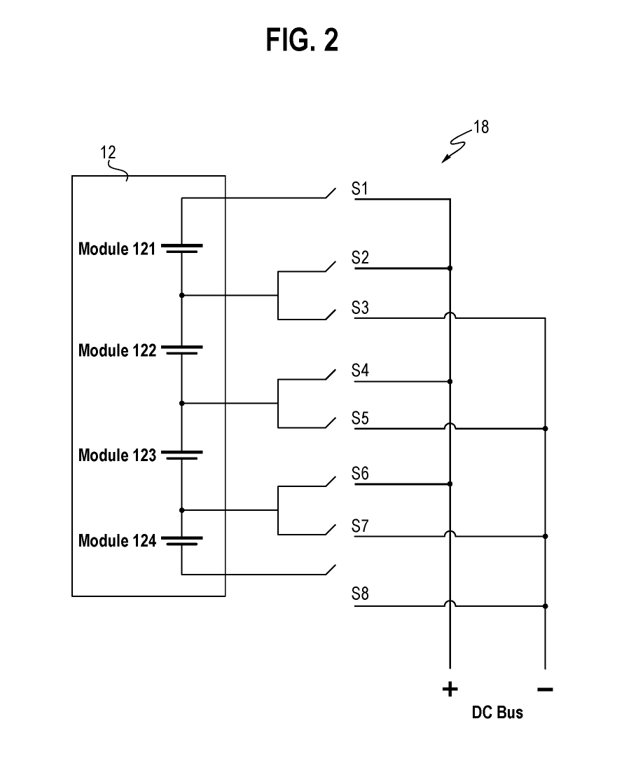

FIG. 2 illustrates a topology of the switch box 18 in the balancing system 10 having four battery modules. As shown in FIG. 2, there are eight digital controlled switches S1-S8 for four battery modules in the battery pack 12 as an example. However, the topology of the switch box 18 may be changed according to the number of the battery module in the battery pack 12. If the total battery module is n, the number of switches in the switch box is 2n. Generally, for practical EVs, the number of the battery module is limited. These switches can be packaged into a small circuit board with MOSFETs (metal-oxide semiconductor field-effect transistors), installed out of the battery pack or integrated with the solar panel/DC-DC converter. Thus no modification or re-development is needed for battery modules, which make the balancing system easy to be added on. As shown in FIG. 2, all switches in the switch box 18 are normally opened. The controller 26 communicating with the switch box 18 measures the voltage or estimates the State-of-Charge (SOC) of each battery module 121, 122, 123 and 124 of the battery pack 12, and closes the corresponding switches S1-S8 to link the battery modules 121, 122, 123 and 124 needed to be charged/discharged to the DC bus. Only two switches can be closed at the same time. For example, for charging or discharging the first battery module 121, two switches S1 and S3 are closed. In addition, switches linked to the same DC bus terminal and same battery module terminal never be closed at the same time to avoid short circuit of DC bus or the battery modules.

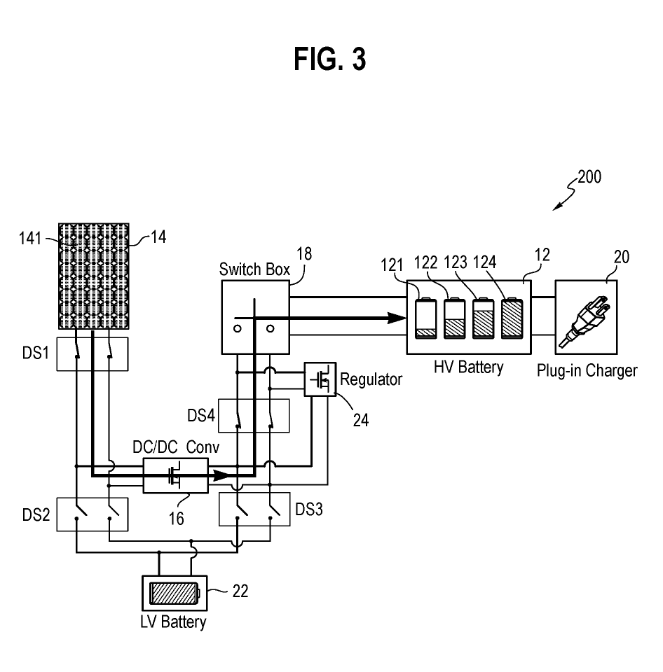

According to a form of the present disclosure, FIG. 3 is illustrating a solar-balancing mode 200 of the battery module balancing system 10. The solar-balancing mode 200 charges the battery modules 121, 122, 123 and 124 at low voltage (or low SOC) in the battery pack 12 by solar power. As shown in FIG. 3, when the weather is sunny and the vehicle is under driving (as external conditions of the vehicle), DS1 and DS4 is closed. Under this condition, the voltage of the battery pack 12 is discharged for transmitting the power to the powertrain system 28 (ex. electric motor) in the vehicle (see FIG. 1). One of the battery modules 121, 122, 123 and 124 with the lowest SOC/voltage is linked to the output of the DC/DC converter and charged by the solar power system 141. Once all the battery modules are balanced to the same SOC/voltage, the battery pack 12 is connected to the DC bus and charged. Thus solar energy from the solar power system 141 is still harvested. In FIG. 3, the solid arrows indicate the energy flow in the solar-balancing mode 200 of the balancing system 10.

Table 1 below shows the switch box status of the solar-balancing mode 200 in FIG. 3. The maximum power harvested from the solar power system 141 and charged to the battery modules by the solar power system 141 is given by the equation (1), Pₘ=(nₛ×Vₘ)×(nₚ×Iₘ)×η_{c}, where Pₘ is the maximum power charged to the battery module by the solar power system 141, nₛ and nₚ are the number of series and number of parallel panels in array, Vₘ and Iₘ are the module voltage and current for each panel at MPPT, and η_{c} is the efficiency of the DC/DC converter 16.

TABLE I
SOLAR-BALANCING MODE SWITCH STATUS

| S1 | S2 | S3 | S4 | S5 | S6 | S7 | S8 | Charged Module |
|---|---|---|---|---|---|---|---|---|
| CLOSE | OPEN | CLOSE | OPEN | OPEN | OPEN | OPEN | OPEN | Module 121 |
| OPEN | CLOSE | OPEN | OPEN | CLOSE | OPEN | OPEN | OPEN | Module 122 |
| OPEN | OPEN | OPEN | CLOSE | OPEN | OPEN | CLOSE | OPEN | Module 123 |
| OPEN | OPEN | OPEN | OPEN | OPEN | CLOSE | OPEN | CLOSE | Module 124 |
| CLOSE | OPEN | OPEN | OPEN | OPEN | OPEN | OPEN | CLOSE | Balanced |

Accordingly, since the battery modules 121, 122, 123 and 124 by the solar energy of the solar-balancing mode 200 operated in the battery module balancing system 10 are balanced, the balancing system 10 reduces the energy loss and improves the efficiency of the system 10.

In addition to the solar-balancing mode 200 that charges the battery modules at low voltage (or low SOC) by the solar power, due to the limitation and unpredictability of the solar power, the present disclosure also provides a storage-balancing mode 300 to balance the battery modules 121, 122, 123 and 124 in the battery pack 12 during discharging using the stored energy in the low voltage battery 22 and a charge-balancing mode 400 to save the active discharge energy and store together with the solar energy to the low voltage battery 22 during the vehicle's parking period. The operating modes of the present disclosure is selected based on the vehicle and the weather conditions.

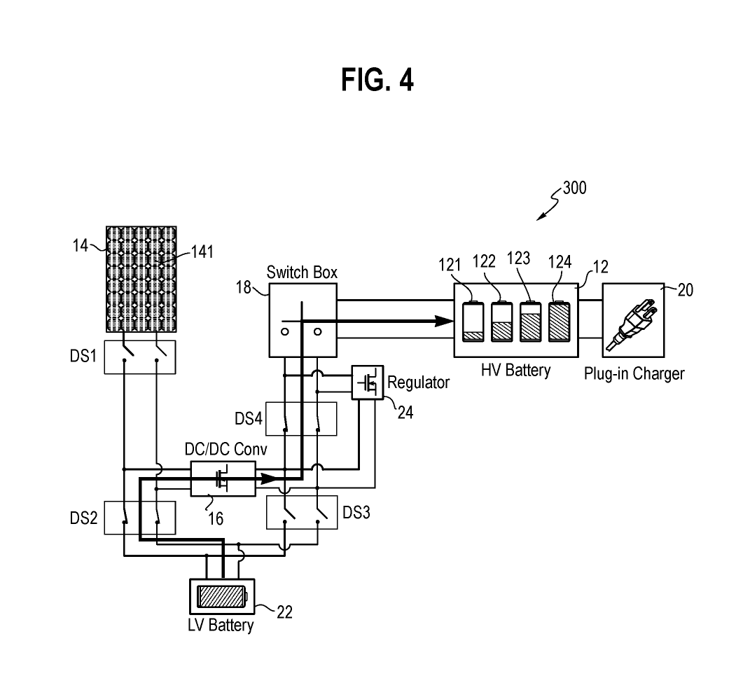

Referring to FIG. 4, when there is little or no solar power to harvest (such as during cloudy days or at night as external conditions of the vehicle), DS1 and DS3 are opened, and DS2 and DS4 are closed to run the storage-balancing mode 300. As shown in FIG. 4, under this mode, the energy saved in the low voltage battery 22 is transferred to one of the battery modules 121, 122, 123 and 124 at the lowest SOC/voltage in the battery pack 12 through the DC/DC converter 16. In FIG. 4, the solid arrows indicate the energy flow in the storage-balancing mode 300 of the balancing system 10. Since the energy saved in the low voltage battery 22 is limited, once the battery modules 121, 122, 123 and 124 in the battery pack 12 are balanced, the energy flow from the low voltage battery 22 is stopped by communicating with the controller 26.

Table II below shows the switch box status of the storage-balancing mode 300 in FIG. 4. The balancing charging power of the storage-balancing mode 300 is controlled by the output voltage of the DC/DC converter 16 and given by the equation (2),

$${P}_{c} = \frac{{V}_{o} - {V}_{oc}}{{R}_{in}} \times {V}_{t} ,$$

where P_{c} is the charging power to the battery at the lowest voltage or SOC, Vₒ is the output voltage of the DC/DC converter, and V_{oc}, Rᵢₙ and Vₜ are the charged battery module open-circuit voltage, internal resistance and terminal voltage, respectively.

TABLE II
STORAGE-BALANCING MODE SWITCH STATUS

| S1 | S2 | S3 | S4 | S5 | S6 | S7 | S8 | Charged Module |
|---|---|---|---|---|---|---|---|---|
| CLOSE | OPEN | CLOSE | OPEN | OPEN | OPEN | OPEN | OPEN | Module 121 |
| OPEN | CLOSE | OPEN | OPEN | CLOSE | OPEN | OPEN | OPEN | Module 122 |
| OPEN | OPEN | OPEN | CLOSE | OPEN | OPEN | CLOSE | OPEN | Module 123 |
| OPEN | OPEN | OPEN | OPEN | OPEN | CLOSE | OPEN | CLOSE | Module 124 |
| OPEN | OPEN | OPEN | OPEN | OPEN | OPEN | OPEN | OPEN | Balanced |

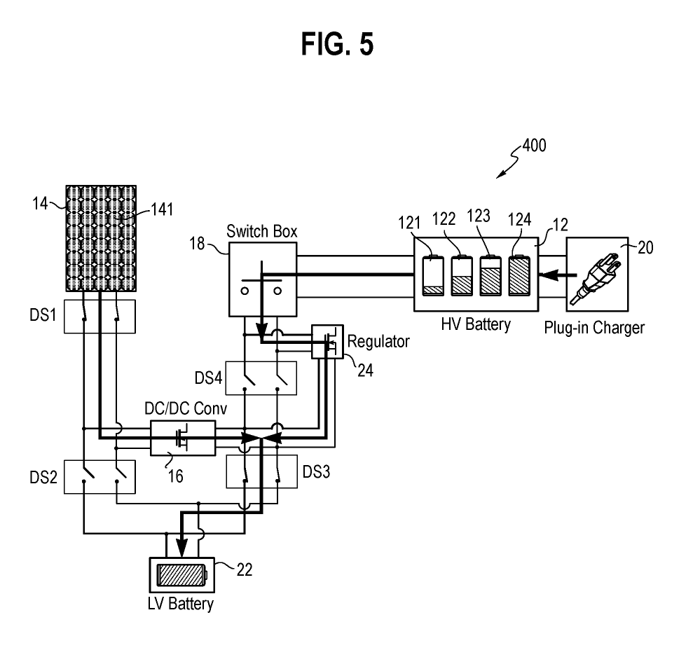

As shown in FIGS. 3 and 4, two modes 200 and 300 described above are used when the vehicle is driving and the battery pack 12 is being discharged by transmitting the energy to the powertrain system 28 (see FIG. 1). Referring to FIG. 5, however, when the vehicle is parked and charged, the charge-balancing mode 400 is operated by closing DS1 and DS3. As shown in FIG. 5, under this mode, the battery pack 12 is being charged by the plug-in charger 20 (as external conditions). The controller 26 in the balancing system 10 monitors the battery module voltages or SOC and links one of the battery modules 121, 122, 123 and 124 with the highest voltage or SOC to the DC bus. The voltage or SOC of the battery module is discharged by the regulator 24. In FIG. 5, the solid arrows indicate the energy flow in the charge-balancing mode 400 of the balancing system 10.

Table III below shows the switch box status of the charge-balancing mode 400 in FIG. 5. The discharging power of the battery module with the highest voltage under this mode is controlled by the output voltage of the regulator 24 and given by the equation (3),

$${P}_{d} = \frac{\frac{{V}_{o}^{′} - {V}_{oc}^{′}}{{R}_{in}^{′}} \times {V}_{t}^{′}}{{η}_{r}} ,$$

where P_{d} is the discharging power of the battery with the highest voltage, V′ₒ is the output voltage of the voltage regulator, V′_{oc}, R′ᵢₙ and V′ₜ are the storage cell open-circuit voltage, internal resistance and terminal voltage, respectively, and ηᵣ is the efficiency of the regulator 24.

TABLE III
CHARGE-BALANCING MODE SWITCH STATUS

| S1 | S2 | S3 | S4 | S5 | S6 | S7 | S8 | Discharged Module |
|---|---|---|---|---|---|---|---|---|
| CLOSE | OPEN | CLOSE | OPEN | OPEN | OPEN | OPEN | OPEN | Module 121 |
| OPEN | CLOSE | OPEN | OPEN | CLOSE | OPEN | OPEN | OPEN | Module 122 |
| OPEN | OPEN | OPEN | CLOSE | OPEN | OPEN | CLOSE | OPEN | Module 123 |
| OPEN | OPEN | OPEN | OPEN | OPEN | CLOSE | OPEN | CLOSE | Module 124 |
| OPEN | OPEN | OPEN | OPEN | OPEN | OPEN | OPEN | OPEN | Balanced |

As shown in FIG. 5, under this mode, the discharging energy from the battery pack 12 as well as the harvested solar energy from the solar power system 141 is saved in the low voltage battery 22. The maximum charging power from the solar power system 141 also given by the equation (1) in the solar-balancing mode 200 as described above. By operating under the charge-balancing mode 400, accordingly, the balancing system 10 guarantees the discharged energy from the battery pack 12 and available solar energy are not wasted because the discharged energy and the available solar energy are stored in the low voltage battery 22. Unlike in conventional passive balancing systems, the high voltage battery cells are discharged by power resistors which waste this part of energy that is saved as described in the charge-balancing mode 400 according to the present disclosure.

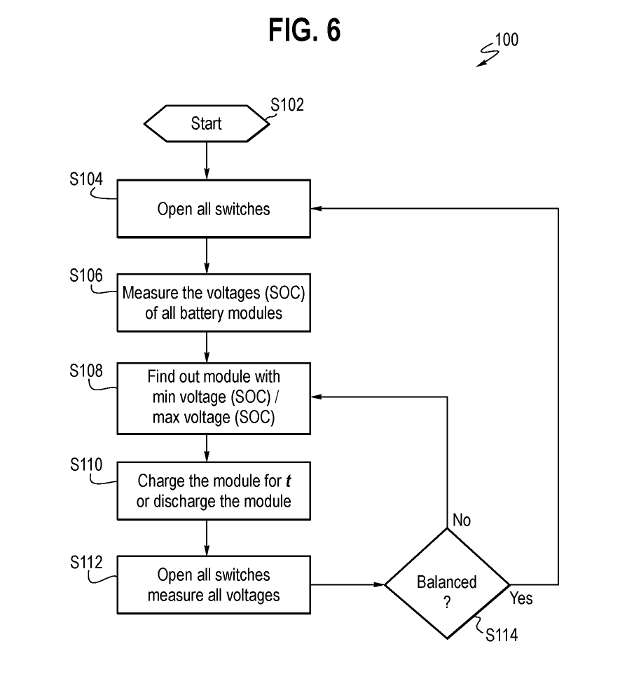

FIG. 6 shows a control flow chart 100 of the battery module balancing system 10 according to a form of the present disclosure. The controller 26 is configured to operate the balancing system 10 by communicating with the components of the system 10. When the battery pack 12 starts to be charged and discharged in a step S102, the controller 26 of the system 10 processes the control algorithm as a circling loop until the system 10 is shut off or the battery pack 12 is fully charged.

In a step S104, all switches S1-S8 in the switch box 18 are opened. In a step S106, the controller 26 measures the voltages or SOC of each of the battery modules 121, 122, 123 and 124 in the battery pack 12. In a step S108, the controller 26 finds out one of the battery modules 121, 122, 123 and 124 with the lowest voltage or SOC when the voltage of the battery pack 12 is discharged, or the highest voltage or SOC when the battery pack 12 is charged by the plug-in charger 20. After finding out one battery module with the lowest voltage (or SOC) or the highest voltage (or SOC) in the step S108, the controller 26 determines to charge the battery module with the lowest voltage (or SOC) or to discharge the battery module with the highest voltage (or SOC) in a step S110.

In the step S110, the controller 26 also determines one of the modes described above for charging or discharging the battery module based on the condition of the vehicle. The controller 26 determines to select the solar-balancing mode 200 for charging the battery module when the solar energy is available for the system 10 and the vehicle is under driving condition. The controller 26 determines to select the storage-balancing mode 300 when there is a little or no solar power to harvest and the vehicle is under driving condition. Also, the controller 26 determines to select the charge-balancing mode 400 when the vehicle is parked and charged by the plug-in charger 20. Accordingly, in the step S110, the controller 26 determines one of the balancing modes in the balancing system 10 for charging or discharging the battery module.

After charging or discharging the battery module with one of the balancing modes in the step S110, the controller 26 opens all switches S1-S8 in the switch box 18 and measures the voltages (or SOC) of each of the battery modules 121, 122, 123 and 124 in a step S112. After measuring the voltages (or SOC) in the step S112, the controller 26 determines whether each of the battery modules 121, 122, 123 and 124 in the battery pack 12 are balanced in a step S114. In the step S114, if the controller 26 determines that the battery modules in the system 10 are balanced, the circling process in the flow chart 100 goes back to the step S104. In the step S114, however, if the controller 26 determines that the battery modules are not balanced, the circling process in the flow chart 100 goes back to the step S108 for finding out one of the battery modules 121, 122, 123 and 124 with the lowest voltage (or SOC) or the highest voltage (SOC).

During the balancing process, when one of the battery modules 121, 122, 123 and 124 is linked to the DC bus, the controller 26 keeps measuring the module voltages only for safety protection, not for charging/discharging selection. This is because, under this condition, the terminal voltage measured for the charging/discharging module is the DC-bus voltage. After being charged/discharged for a certain period t, all switches are opened for a sampling time T and T=1/f, where f is the sampling frequency of the voltage measurement. A new decision on battery module to be charged/discharged is made based on the module voltage measured on sampling period T. Another reason of doing this is for short-circuit protection. The period T also acts as a dead-band between switches status changing. Thus the switches connected to the same terminal of DC bus or battery modules will not be closed at the same time. It is important that the dead-band T (sampling period) is much shorter than the period t for charging (T<<t) for balancing speed and harvesting as much solar power as possible.

As described above, the battery module balancing system 10 has three operation modes 200, 300 and 400. The first mode is the solar-balancing mode 200 selected when the vehicle is driving and the solar power is available for charging low SOC battery modules in the battery pack 12 or charging the whole battery pack 12 when all the battery modules are balanced. In the solar-balancing mode 200, the battery pack 12 is generally charged by the solar power in the solar power system 141. The second mode is the storage-balancing mode 300 selected when the vehicle is under driving but the solar power is not available (for example, in cloudy, rainy weather or at night). In the storage-balancing mode 300, the battery modules in the battery pack 12 is charged by the low voltage battery 22 instead of the solar power. The third mode is the charge-balancing mode 400 selected when the vehicle is parked and being charged. In the charge-balancing mode 400, the solar energy as well as the actively discharged energy from the high voltage battery modules in the battery pack 12 is stored in the low voltage battery 22. Accordingly, the battery modules 121, 122, 123 and 124 in the battery module balancing system 10 are effectively balanced.

Since the energy used for the active battery balancing comes from energy source independent from the battery pack 12, the extra energy loss of the battery pack 12 during balancing is eliminated according to the present disclosure. By taking advantage of the solar energy harvesting, furthermore, the energy used for the battery balancing is also “free”.

While this present disclosure has been described in connection with what is presently considered to be practical exemplary forms, it is to be understood that the present disclosure is not limited to the disclosed forms, but, on the contrary, it is intended to cover various modifications and equivalent arrangements included within the spirit and scope of the present disclosure.

What is claimed is:

1. A battery module balancing system in a vehicle having a powertrain, the battery module balancing system comprising:
a battery pack having at least one battery module, each battery module having a state-of-charge (SOC), the battery pack having energy configured to provide power to the powertrain of the vehicle, the energy being defined by the SOC of the at least one battery module;
a low voltage battery for storing a first voltage and providing the first voltage to the battery pack;
an electric generator for generating a second voltage to one of the battery pack and the low voltage battery; and
a controller in communication with the at least one battery module, the electric generator, and the low voltage battery to balance the SOC of the at least one battery module.

2. The battery module balancing system of claim 1, wherein the electric generator includes a solar power system.

3. The battery module balancing system of claim 2, wherein the solar power system generates the second voltage for balancing the SOC in the battery module by transmitting the second voltage to the battery module during discharging the energy from the battery pack.

4. The battery module balancing system of claim 3, wherein the battery module with a lowest voltage or SOC is charged by the second voltage for balancing the SOC in the battery module.

5. The battery module balancing system of claim 3, wherein the controller balances the SOC in the battery module by the second voltage generated from the solar power system when the vehicle is under driving and a solar power is available as a solar-balancing mode.

6. The battery module balancing system of claim 5, wherein the controller is operable to charge the battery pack with the second voltage generated from the solar power system after the SOC in the battery module is balanced.

7. The battery module balancing system of claim 3, wherein the controller balances the SOC in the battery module by the first voltage stored in the low voltage battery when the vehicle is under driving and a solar power is not available as a storage-balancing mode.

8. The battery module balancing system of claim 7, wherein the controller is operable to stop transmitting the first voltage stored in the low voltage battery when the SOC in the battery module is balanced.

9. The battery module balancing system of claim 1, wherein the controller balances the SOC in the battery module by discharging a waste energy of the battery module with a highest voltage or SOC when the battery pack is charged by a plug-in charger.

10. The battery module balancing system of claim 9, wherein during charging the battery pack with the plug-in charger, the waste energy discharged from the battery module with the highest voltage or SOC is stored in the low voltage battery for preventing a loss of the waste energy.

11. The battery module balancing system of claim 9, wherein during charging the battery pack with the plug-in charger, the second voltage generated from the electric generator is stored in the low voltage battery when the electric generator is available.

12. The battery module balancing system of claim 1, wherein the battery module balancing system further includes a switch box, a DC/DC converter and a regulator for balancing the SOC in the battery module.

13. The battery module balancing system of claim 12, wherein a number of switch in the switch box is determined by doubling a number of the battery module in the battery pack.

14. The battery module balancing system of claim 1, wherein the battery module balancing system further includes a plurality of dual-switches (DS) for selecting different modes by the controller.

15. A method for operating a battery module balancing system in a vehicle having a controller for balancing a state-of-charge (SOC) of at least one battery module in a battery pack, the method comprising steps of:
monitoring the SOC in the at least one battery module;
determining a balancing operation mode based on external conditions of the vehicle;
determining the battery module with a lowest SOC or a highest SOC; and
balancing the SOC in the battery module by charging or discharging the battery module.

16. The method of claim 15, wherein the controller determines a solar-balancing mode for charging the battery module with the lowest SOC by a second voltage generated from a solar power system when the vehicle is under driving and a solar power is available.

17. The method of claim 15, wherein the controller determines a storage-balancing mode for charging the battery module with the lowest SOC by a first voltage stored in a low voltage battery when the vehicle is under driving and a solar power is not available.

18. The method of claim 15, wherein the controller determines a charge-balancing mode for discharging a waste energy from the battery module with the highest SOC when the vehicle is parked and charged by a plug-in charger.

19. The method of claim 18, wherein during charging the battery pack with the plug-in charger, the waste energy discharged from the battery module is stored in a low voltage battery for preventing a loss of the waste energy.

20. The method of claim 18, wherein during charging the battery pack with the plug-in charger, a second voltage generated from a solar power system is stored in a low voltage battery when a solar power is available.
